(19) United States
(12) Patent Application Publication
(10) Pub. No.: US 2017/0044652 A1
(43) Pub. Date: Feb. 16, 2017

(54) Thermally Coated Component

(71) Applicant: Daimler AG, Stuttgart (DE)

(72) Inventors: Thomas BEHR, Elchingen (DE); Jens BOEHM, Neuhausen (DE); Martin HARTWEG, Erbach (DE); Tobias HERCKE, Waldenbuch (DE); Thomas KREISL, Winterbach (DE); Manuel MICHEL, Neuhausen a.d.F. (DE); Guenter RAU, Remseck (DE); Christoph RECKZUEGEL, Hohenstadt (DE); Stefan SCHWEICKERT, Plochingen (DE); Mareike ULRICH, Ludwigsburg (DE)

(73) Assignee: Daimler AG, Stuttgart (DE)

(21) Appl. No.: 15/305,624

(22) PCT Filed: Mar. 13, 2015
(86) PCT No.: PCT/EP2015/000563

§ 371 Date: Oct. 20, 2016

(30) Foreign Application Priority Data
Apr. 24, 2014 (DE) 10 2014 005 947.2

(51) Int. Cl. C23C 4/131; F02F 7/00; F02F 3/10; C23C 4/12; F02F 1/00

(52) U.S. Cl. CPC C23C 4/131; C23C 4/12; F02F 1/004; F02F 3/10; F02F 7/0085

(57) ABSTRACT

A thermally coated component is disclosed. The thermally coated component has a frictionally optimized surface of a track for a friction partner, where the surface has pores. The pores have an entry rounding, the slope of which, as a ratio of the depth of the entry rounding to a longitudinal section of the surface or parallel to the surface, has a value of more than 2.5 μm/mm.

### BACKGROUND AND SUMMARY OF THE INVENTION

The invention relates to a thermally coated component.

It is known from the general prior art to optimize the surface characteristics such as, for example, the friction of components which interact with a friction partner. Components of this type can, for example, be a cylinder and piston pairing, the interaction of which is highly relevant for example in combustion engines. The overall performance and oil consumption of a combustion engine are substantially determined by the friction between these partners, the cylinder inner surface and the piston. It is known from the prior art to create structures by means of corresponding mechanical surface treatment, for example by means of honing, the structures minimizing friction by ensuring that a certain amount of oil is kept in the region of the surface. The intersecting grooves, which occur during honing, are suitable for this.

Furthermore, it is known from the general prior art to provide the cylinder surfaces or even other components that are to be optimized with respect to the tribological characteristics with coatings. One possibility can be, for example, a so-called thermal coating which is enabled in particular by thermal spraying, for example the arc wire spraying or PTWA method (Plasma Transferred Wire Arc). Such surfaces in particular have open pores which also contribute to keeping the oil in the region of the surface. In particular, such a thermally applied coating can be combined with a subsequent machining process such as, for example, honing.

Such a construction is known from DE 10 2012 002 766 A1 of this type. The thermally coated component here is characterized by a certain so-called oil holding or retention volume which ensures that a corresponding, required or theoretically predetermined amount of oil remains in the region of the frictionally optimized surface during operation, so when the friction partners slide on one another. Optimum component pairings can hereby be created with respect to friction, preferably for cylinder tracks in combustion engines.

A coating is known from U.S. Pat. No. 5,863,870 A which has good tribological characteristics. On this occasion, it is an iron-based coating which contains micropores. The coating can then be smoothed by means of a honing method.

A method for the production of a sliding surface on a light metal alloy is known from WO 97/16577 A1 and DE, 44 40 713 A1, in which the layer is applied by thermal spraying, in particular plasma spraying. Furthermore, a slide bearing and a method for its production are known from DE 10 2010 053 326 A1, Here, an additional material is applied by means of laser coating and then treated by cutting and/or etched.

For further prior art, “Barbezat G. et al,: Plasmabeschichtungen von Zylinderkurbelgehäusen und ihre Bearbeitung durch Honen, in MTZ Motortechnische Zeitschrift, Vieweg Verlag, Wiesbaden, D E, Vol. 62 No. 4, 1 April 2001, pages 314 to 320” can be referred to.

The object of the present invention now consists in further optimizing such a surface of a thermally coated component.

The thermally coated component according to the invention is implemented in such a way that pores occurring in the thermally coated surface are optimized with respect to an entry rounding in such a way that a slope of the entry rounding, which is calculated from a ratio of the depth of the entry rounding to a longitudinal section of the surface or parallel to the surface in which the pore is located, has a value of more than 2.5 μm/mm in each case. Such a slope of the entry roundings, for example averaged over the entire surface for all pores of more than 2.5 μm/mm, enables an additional, significant increase in the oil holding volume by means of correspondingly smooth transitions of the pore edges into the actual surface. Such surface characteristics have a very positive effect on the wear of friction partners, for example in the case of a thermally coated cylinder track on the wear of piston rings.

Such high slope values of the entry rounding can be achieved in particular by honing with ceramic honing stones, preferably when honing with diamond honing stones is carried out beforehand. Here, ceramic honing stones are understood to be honing stones with ceramic cutting materials, for example silicon carbide (SiC) or aluminum oxide (Al2O3), preferably in a ceramic bond. Grain sizes for the ceramic cutting materials of more than 400 mesh (approx. 40 μm) have been found to be suitable for this. However, diamond honing stones have diamond cutting materials in metallic bonds. In principle, the cutting materials can also be bound to the honing stones by means of a synthetic resin bond or a plastic bond, the abovementioned bonds are, however, more advantageous for economical reasons (lifetime of honing stones, tool costs, preparing the tools).

Honing stones which are usually used, such as, for example, diamond honing stones, leave behind pores which have an entry rounding with a correspondingly flat transition between the pore edge and the actual entry rounding and therefore a rather small slope value, which is typically in the range of between 0.5 and 1.5. It is surprising that the slope of the entry roundings can be increased to values of more than 2.5 μm/mm, typically to values between 3 and 5.5 μm/mm, by means of preferably subsequent honing with ceramic honing stories. The surface then has a very smooth cover structure which has correspondingly open porosity without a covering of the individual pores. The oil holding volume can be significantly increased again compared to the prior art, in particular by approx. 40-50%, by means of the high slope values and the correspondingly smooth transitions of the pore edges into the entry roundings.

In order to detect the entry rounding, a boundary line can be detected, for example, which separates the region of the entry rounding of the pore from the surrounding surface. For this purpose, an average height level of the surface surrounding the respective pore is firstly determined (for example by means of white-light interferometry or also other common measurement techniques). Points belonging to this pore are then determined, the points being lowered with respect to this average height level (by a predetermined value, for example the resolution limit of the respective measurement technique) and adjoining the surrounding surface. These points then form the boundary line of this pore.

A tangent to the boundary line is then formed at least at some points of the boundary lines. The average increase of the entry rounding is detected perpendicularly to this tangent along a defined measuring section. The average increases of all measuring sections of the pore are then averaged in order to obtain an average value for the entry rounding of the respective pore, which is then formulated as a so-called slope of the entry rounding of the respective pore. The method can then be carried out on other pores in order to obtain an average of all slopes of all entry roundings of all pores for the entire surface or individual sections of the surface.

Alternatively, it is also conceivable to work with several boundary lines. In addition, a first boundary line is firstly detected again which separates the region of the rounding of the pore from the surrounding surface. Additionally, in this alternative, care must be taken to ensure that the first boundary line runs at the first defined height level. A second boundary line is then formed within which is moved in the direction of the pore, ideally in the region in which the entry rounding is separated from the pore itself, and which also runs at a defined height level. A height difference can be determined if the height is known for the two boundary lines. This height difference can then be divided by the average spacing of the boundary lines from one another in order to obtain an average slope of the entry rounding of the respective pore.

The measurement values can thereby be determined by an extensive surface measurement method, in particular white-light interferometry, and are then converted with a three-dimensional data set based on the measurement. This can then be used, for example, using an image processing method to determine the boundary lines, the increases and the slope.

As has already been mentioned, slopes of more than 2.5 μm/mm of the entry roundings of the pores enable a significant improvement of the tribological characteristics of the surface.

According to an advantageous development of the thermally coated component according to the invention, it can thereby be provided that the frictionally optimized surface is mechanically treated, preferably treated by cutting. This machining, which can be implemented as honing in particular, thereby takes place after the thermal coating has been applied, for example after a cylinder surface or a cylinder liner has been coated by means of thermal spraying on the surface. The surface quality is then improved by means of honing and the surface, for example the cylinder, is adjusted to the desired dimensions.

According to a very advantageous development of the idea, the frictionally optimized surface can thereby be finished by means of multistage honing, wherein honing is firstly carried out with diamond honing stones and then with ceramic honing stones. In particular, such pre-treatment with diamond honing stones and a subsequent post-treatment with ceramic honing stones results in very favorable entry roundings, in such a way that the advantageous slope values of the entry roundings of more than 2.5 μm/mm, preferably more than 3 μm/mm, can be achieved. As a result, the tribological characteristics of the frictionally optimized surface can again be further increased, in particular by means of further significantly increased oil holding volumes compared to prior art.

Further advantageous embodiments of the thermally coated component arise from the remaining dependent sub-claims and are clear from the exemplary embodiment, which is described in greater detail below with reference to the figures.

### BRIEF DESCRIPTION OF THE DRAWINGS

FIG. 1 illustrates a surface having an exemplary pore;

FIG. 2 shows the pore from FIG. 1 having a boundary line between the rounding of the pore and the surface surrounding the pore;

FIG. 3 is a schematic diagram of a cross section through the part of a pore to visualize the entry rounding;

FIG. 4 is a sectional enlargement with marked tangents and measuring sections for the first method according to the invention;

FIG. 5 is a pore having two boundary lines to clarify the second method according to the invention;

FIG. 6 is a schematic diagram of a cross section of the pore having the two boundary lines according to FIGS. 5; and

FIG. 7 is a diagram with slope values for different pores which have been treated in different ways.

### DETAILED DESCRIPTION OF THE DRAWINGS

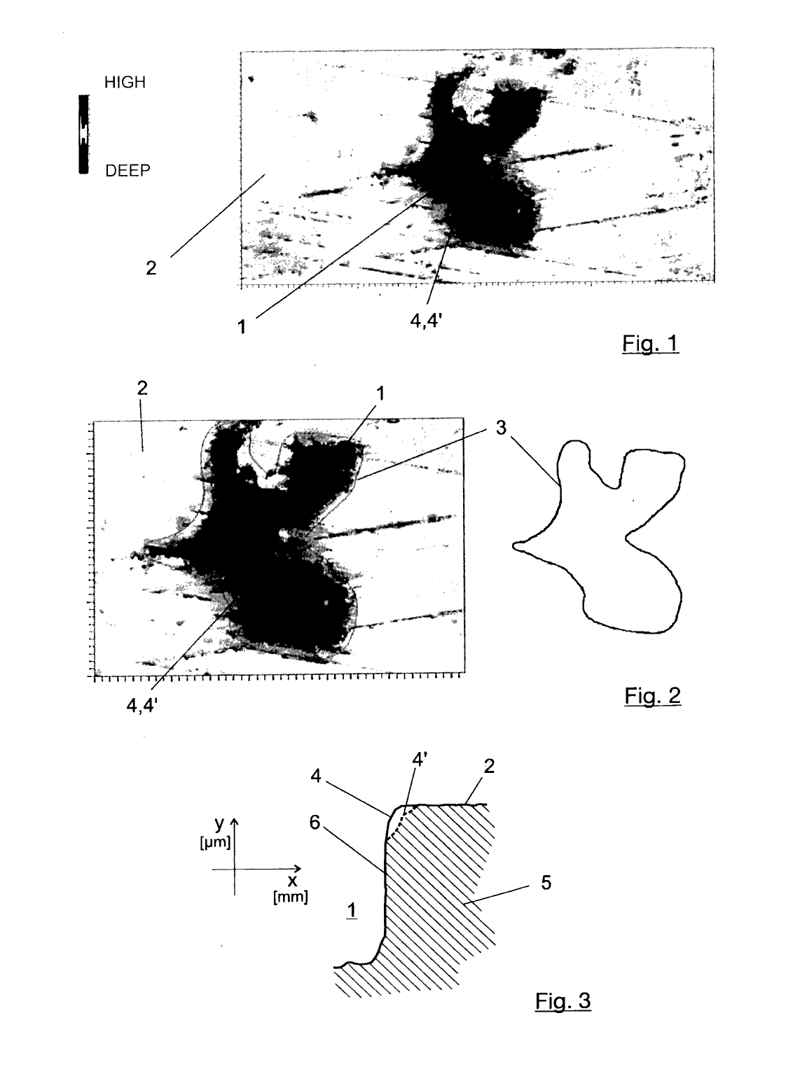

in the depiction of FIG. 1, a pore 1 in a thermally sprayed frictionally optimized surface 2 is shown purely by way of example. The depiction of FIG. 1 converted to greyscale originates from white-light interferometry and shows different colors or just different shades of grey depending on the height of the material. The depiction in FIG. 1 thus finally portrays a three-dimensional topography of the measured surface 2 having the pore 1 and the surface 2 surrounding the pore 1. In particular, this three-dimensional image of the topography of the surface 2 can then be further processed using image processing methods. In the depiction of FIG. 2, the pore 1 can be seen again similarly to the depiction in FIG. 1 on the left-hand side of the depiction of FIG. 2. In contrast to the depiction in FIG. 1, a boundary line 3 is marked here and is depicted again separately in the right-hand depiction of FIG. 2. This boundary line 3, which could also be referred to as the first boundary line, as shown again later, thereby separates the region of a so-called entry rounding 4, which can be recognized in the depictions of FIGS. 1 and 2 in corresponding shades of grey, from the surface 2 surrounding the pore 1. In addition, an average height level for the surface 2 surrounding the pore 1 is firstly determined by means of white-light interferometry. Points belonging to this pore 1 are then determined, the points being lowered with respect to this average height level by the double resolution limit and adjoining the surrounding surface. These points then form the boundary line 3 of the pore 1 with respect to the surface 2.

In the depiction of FIG. 3, this is depicted again in a schematic sectional view of a side of the pore 1. The measurement is therefore selected in μm in the y direction and mm in the x direction, whereby a distorted image results. This is required, however, for the visualization of the entry rounding. The pore 1 is to be recognized as a partial recess in the surface 2 of the material referred to by 5, for example a thermally sprayed coating. A connection of the actual pore 1 to the surface 2 can thereby be recognized with a solid line which shows a relatively flat transition of an edge 6 of the pore 1 into the region of the entry rounding 4 and thus into the surface 2. A relatively smooth transition of the pore edge 6 into the entry rounding 4 is thus shown with the solid line. A further entry rounding 4 is shown with the dashed line, which is referred to in the depiction of FIG. 3 by 4, the entry rounding being much sharper in the transition to the pore edge than the entry rounding referred to by 4.

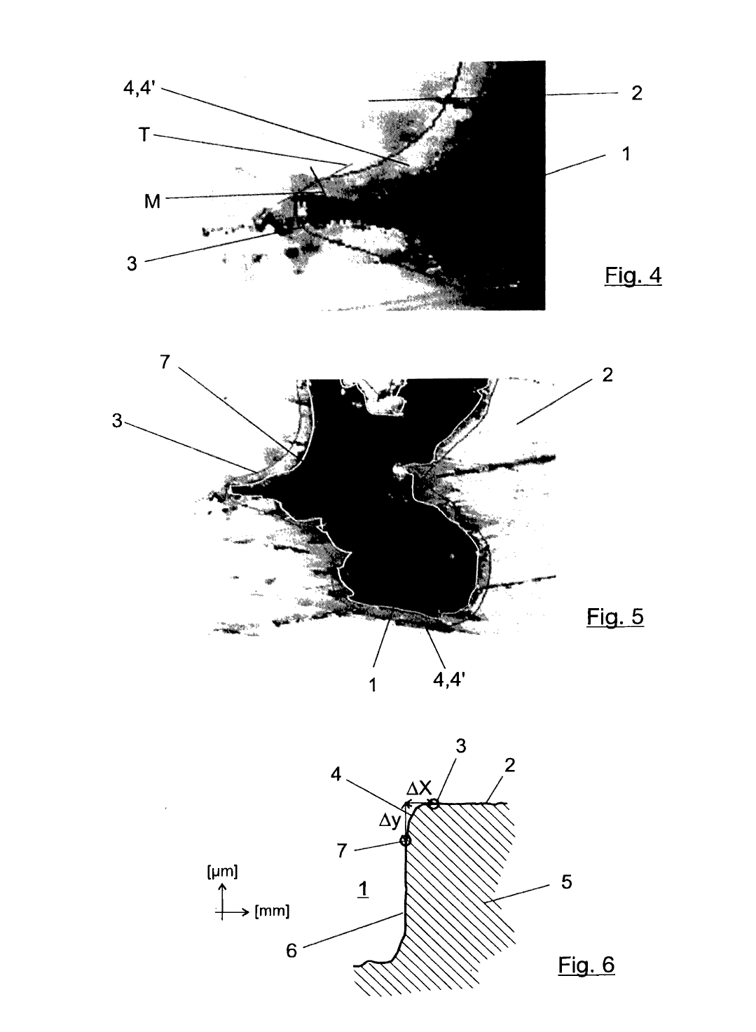

The entry rounding 4, 4′ can now, depending on how it turns out, indeed have an influence on the function of the component or the coating 5. It is therefore desirable to metrologically determine this entry rounding 4, 4′ as one of the parameters of the surface 2. Based on the image depicted in FIG. 2, a so-called slope of the entry rounding 4, 4′ can now be determined with corresponding image processing methods, by applying, for example, as is indicated in the depiction of FIG. 4, a tangent which is referred to by T, to one, in particular however for each point, of the boundary line 3. A measuring section M of a defined length is formed perpendicularly to this tangent T, wherein the length thereof is determined symmetrically to the boundary line 3 both in the direction of the pore and in the direction of the surroundings. In the case of the structures considered here as an example, the total length of the measuring section M is 60 μm. Then, starting from the beginning of the measuring section M outside the boundary line 3 inwards in the direction of the pore 1, the average increase, for example with a linear regression method, is detected along the measuring section M. If this increase is now determined along the boundary line 3 at several, in particular in all, points of this boundary line 3, then a corresponding average value can be formed such that a corresponding average increase of the entry rounding 4 of the pore 1 can be obtained.

This average increase is then formulated as a so-called slope of the entry rounding 4, 4′. Therefore, calculation is carried out with the coordinates x and y marked in FIG. 3, by using the ratio of the measured depth y of the entry rounding 4, 4′ with respect to the surface 2 surrounding it, proportionally or normalized to an average longitudinal section x parallel to the surface 2 (corresponding to the average value of all projections of all measuring sections M). The following formula results:

A=y/x in [μm/mm].

The value of the slope A is preferably specified in μm/mm of the longitudinal section x in the direction of the surface 2. The bigger this value is, the smoother the transition is from the pore surface 6 to the surface 2. A correspondingly smooth transition corresponds to the depiction of FIG. 3, which is not to scale, of the entry rounding referred to by 4. If the value of the slope is smaller, then the transition to the pore edge 6 is less smooth and could correspond, for example, to the transition referred to by 4′ in the depiction of FIG. 3.

Based on the values for the slope A obtained in this way, for example the slope A of pore 1 or the average slope A for all pores 1 of a surface section or the whole surface 2 the geometry of the entry roundings 4, 4′ can be compared correspondingly very easily, which facilitates the function-oriented measurement of the surface 2 and a good comparability of the surface 2 is enabled by means of the measured entry rounding shown in the figures via the average slope A in μm/mm, for example after treatment with different tools and/or different coatings 5.

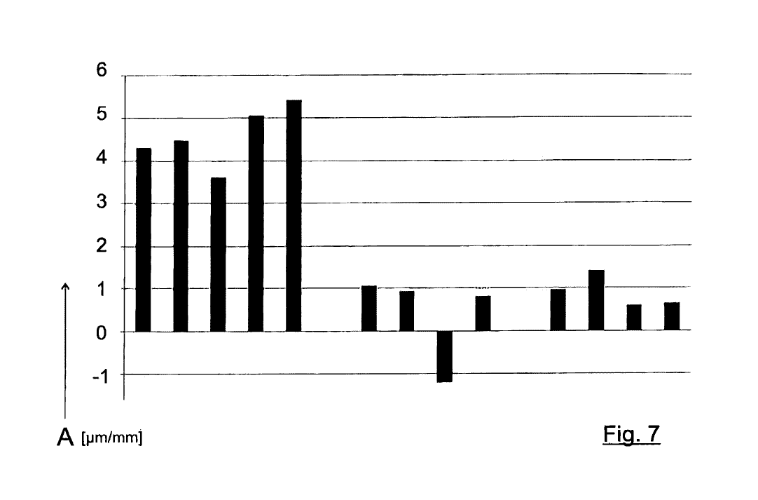

In order to facilitate a boundary of the measuring section M, in addition to the boundary line 3, a pore edge line 7 can be created which separates the region of the entry rounding 4, 4′ of the pore 1 from the pore 1 itself. This pore edge line 7 then forms the inner boundary of the measuring section M perpendicularly to the tangent T. To clarify, such a pore edge line 7 is marked in the depiction of FIG. 6.

If the pore edge line 7 runs at a height level as in this case, just as the first boundary line 3, it can also be used for an alternative method for determining the increase of the entry rounding 4, 4′. In this case, the pore edge line 7 forms a second boundary line 7, while the boundary line 3 forms a first boundary line 3. In this case, it must be ensured that both boundary lines 3, 7 run at the same (average) height level in relation to the surface 2. This then results in the exemplary course shown in the sectional depiction of FIG. 6, in which course the first boundary line referred to by 3 in the depiction is at the level of the surface 2, while the second boundary line 7 is indicted below by a certain section of the height Δy. if one now determines the average spacing Δx of these two boundary lines 3, 7 over the whole circumference of the pore 1 and, at the same time, the height difference Δy between the two boundary lines 3, 7, an increase or the slope A=y/x can be calculated from these values.

The method can be used as an alternative to the aforementioned method and can be quicker than the abovementioned method, depending on image processing, if required, and correspondingly takes less computing power. Otherwise, it is also the case here that a corresponding method can be carried out for each pore and that, correspondingly for the whole surface 2 or for sections of the surface 2, the rounding of the respective pores 1 is available individually or as an average value in order to carry out a function-oriented assessment of the surface 2. It is of course also possible, instead of two boundary lines 3, 7, to use more than two boundary lines and/or assess some of the pores 1 using the first method described and other pores 1 using the second method described with respect to the slope A of their entry roundings 4, 4′.

The slope A can now additionally be used in particular to assess the tribological characteristics of the frictionally optimized surface 2. In the diagram of FIG. 7, the average slopes A are plotted for individual pores I treated with different production methods. The pores 1 are therefore located in a thermal coating 5 which is applied to a cylinder liner or a cylinder housing for a combustion engine of a motor vehicle. The average slope A of pores 1 is determined by means of the method described above, after the pores 1 have been honed in the usual manner with a diamond honing tool. These average slopes A of the surface 2 honed with diamond tools can be found to the far right in the diagram of FIG. 7. They have values between −1 and +1.5 for the slope. These values are therefore relatively low, Which speaks for a fairly sharp-edged transition of the pore edge 6 into the region of the rounding 4. The rounding for these pores 1 of the surface 2 which have only been treated with diamonds would thus correspond to the entry rounding 4 from the depiction of FIG. 3. The negative measurement value therefore has to do with the fact that, here, material has been found piled up in the region of one of the pores I such that a negative slope has resulted.

In the diagram of FIG. 7, the measurement values of five pores can be found at the far left which have been achieved in the surface 2 after treatment with diamond honing tools and a subsequent post-treatment with tools having ceramic honing stones. The slope values are all significantly above 2.5 μm/mm, in particular above 3.5 μm/mm, and in most cases even above 4. Such high slope values, which speak for a correspondingly smooth transition of the pore edge 6 into the entry rounding 4, are designed, for example, as is indicated in the depiction of FIG. 3 as an entry rounding 4. Such a design of the pores 1 then enables a correspondingly high oil holding volume such that the best tribological characteristics for the frictionally optimized surface 2 can be achieved.

1-7. (canceled)

8. A thermally coated component, comprising:
a surface of a track for a friction partner, wherein the surface has a pore, wherein the pore has an entry rounding, and wherein a slope of the entry rounding, as a ratio of a depth of the entry rounding to a longitudinal section of the surface or parallel to the surface, has a value of more than 2.5 μm/mm.

9. The thermally coated component according to claim 8, wherein an average slope for a plurality of pores of the surface is more than 3 μm/mm.

10. The thermally coated component according to claim 8, wherein the surface has been mechanically treated.

11. The thermally coated component according to claim 10, wherein the surface has been mechanically treated by cutting.

12. The thermally coated component according to claim 8, wherein the surface has been treated by honing.

13. The thermally coated component according to claim 8, wherein the surface has been treated with a tool having diamond honing stones and with a tool having ceramic honing stones.

14. The thermally coated component according to claim 8, wherein a thermal coating of the thermally coated component is a thermal spray coating.

15. The thermally coated component according to claim 14, wherein the thermal spray coating is an are wire spraying layer or a plasma transferred wire arc (PTWA) layer.

16. The thermally coated component according to claim 8, wherein the thermally coated component is a cylinder crankcase or a piston or a hush or a cylinder liner.
